(19) United States
(12) Patent Application Publication
(10) Pub. No.: US 2014/0115967 A1
(43) Pub. Date: May 1, 2014

(54) SLIDING COVER STRUCTURE

(71) Applicants: LITE-ON ELECTRONICS (GUANGZHOU) LIMITED, Guangzhou (CN); LITE-ON TECHNOLOGY CORPORATION, Taipei City (TW)

(72) Inventor: CHING-CHIH LIN, KAOHSIUNG CITY (TW)

(73) Assignees: LITE-ON TECHNOLOGY CORPORATION, TAIPEI CITY (TW); LITE-ON ELECTRONICS (GUANGZHOU) LIMITED, GUANGZHOU (CN)

(21) Appl. No.: 13/717,654

(22) Filed: Dec. 17, 2012

(30) Foreign Application Priority Data
Oct. 26, 2012 (CN) 201220556305.7

(51) Int. Cl. E06B 3/50

(52) U.S. Cl. CPC E06B 3/5018
USPC 49/258

(57) ABSTRACT

A sliding cover structure having a flappable cover is provided. A first groove and a second groove are disposed on the interior wall of the accommodating case. The cover has a plate portion and a connection wall disposed on the side of the plate portion. The connection wall has a first pivot movably disposed in the first groove, and a second pivot movably disposed in the second groove. The direction of the first groove is overall perpendicular to the plate portion. The second groove is slanted with respect to the first groove. When the first and second pivots slide and rotate respectively within the first and second groove, an effect of moving towards the center is produced to effectively reduce the space required for operation of the structure. Moreover, the cover is housed inside the accommodating case during opening, reducing the risk of impact.

### BACKGROUND OF THE INVENTION

1. Field of the Invention

The invention relates to a sliding cover structure, more particularly to a sliding cover structure that is able to quickly open and close a sliding cover therefrom with sliding and rotational function in order to be protected from external impact.

2. Description of Related Art

In order to protect the contents inside the cases, the openings are equipped with covers. A typical cover structure is required to keep the cover securely closed and to allow the cover to be easily opened. Proper use of the cover structure may result in excellent protection effect. However, after the cover is opened, the cover protrudes from the case and is relatively easily damaged.

For example, generally electrical connectors or external sockets are widely applied on electrical devices for connection with other electrical devices. Even electrical appliances such as video players, televisions, refrigerators, and microwave ovens are equipped with electrical connectors or external sockets. Cover protection is needed on these electrical connectors (or external sockets) to prevent foreign matters such as humidity and dust from entering the electrical devices. Therefore the electrical devices are preferably smaller, and a design for covers on electrical connectors needs to consider how to minimize the space required for closing and opening.

In the current market, the electrical devices are provided with accommodating spaces therefrom with covers to cover the openings for convenient plugging and unplugging of electrical connectors, and protect the electrical connectors or the electrical sockets within. However, the accommodating spaces need to accommodate the electrical connector, the covers and the space required for the operation of the covers. The operation of these covers is not convenient, and sometimes requires fingers to hold, pull and push. Moreover, the covers protrude from the case when opened, and are susceptible to damage from impact. These existing designs of electrical appliances are inconvenient, which reduces the overall effect thereof.

### SUMMARY OF THE INVENTION

The object of the invention is to provide a sliding cover structure, which employs two rotating pivots with two uniquely arranged grooves to allow the user to close or open the cover by pushing the cover in a single direction.

The object of the invention is to further provide a sliding cover structure such that the cover is opened, closed and housed within a limited space in order to reduce its protruding portion and to protect the plate portion.

In order to achieve the aforementioned objects, the invention provides a sliding cover structure which includes an accommodating case and a cover. The accommodating case has an opening. Each of the interior lateral walls of the accommodating case has a first groove and a second groove. The cover has a plate portion selectively covering the opening, and a connection wall connected to the plate portion. The connection wall has a first pivot movably disposed in the first groove, and a second pivot movably disposed in the second groove. With this design, the cover can selectively cover the accommodating case in a closed position or slip into the accommodating case in an open position.

An advantage of the invention is that a simple push by the user can conveniently open and close the cover by utilizing two pivots acting in conjunction with two uniquely arranged grooves.

In order to further the understanding regarding the invention, the following embodiments are provided along with illustrations to facilitate the description of the invention.

### BRIEF DESCRIPTION OF THE DRAWINGS

FIG. 1 shows a perspective exploded diagram of a sliding cover structure of the invention;

FIG. 2 shows a perspective exploded diagram of a sliding cover structure of the invention of another embodiment;

FIG. 3 shows a top view diagram of the sliding cover structure of FIG. 2;

FIG. 4 shows a side view diagram of the sliding cover structure of FIG. 2 (cross-sectioned along line AA of the accommodating case of FIG. 2);

FIG. 5 shows a perspective diagram of the sliding cover structure of FIG. 2 after assembly;

FIG. 6A to FIG. 6D are side view diagrams of the operation process of the cover;

FIG. 7 shows a perspective diagram of the cover of FIG. 2 in an open state;

FIG. 8 shows a top view diagram of the cover of FIG. 2 in a closed state;

FIG. 9 shows a top view diagram of a sliding cover structure of the invention applied and closed on an electronic device; and

FIG. 10 shows a top view diagram of a sliding cover structure of the invention applied and open on an electronic device.

### DETAILED DESCRIPTION OF THE PREFERRED EMBODIMENTS

The aforementioned illustrations and following detailed descriptions are exemplary for the purpose of further explaining the scope of the present disclosure. Other objectives and advantages related to the present disclosure will be illustrated in the subsequent descriptions and appended drawings.

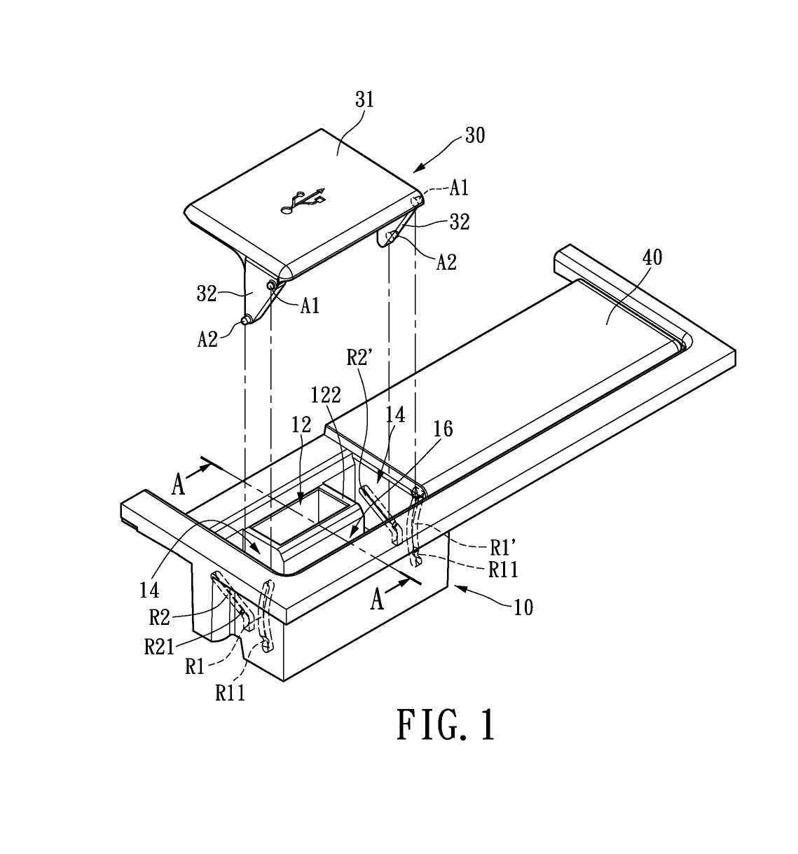

FIG. 1 is a perspective exploded diagram of the sliding cover structure of the invention. The sliding cover structure of the present embodiment includes an accommodating case 10 and a cover 30. The accommodating case 10 can accommodate objects within, for example an electrical connector (not shown). The cover 30 is movably configured inside the accommodating case 10, such that the cover 30 is movably covering the accommodating case 10 or housed within the accommodating case 10 to expose the contents accommodated therein. The present embodiment uses electrical connectors, such as a USB connector, as an example but the possible contents are not limited thereto.

The accommodating case 10 has an opening. At least one lateral wall inside the accommodating case 10 has a first groove R1 (R1′) and a second groove R2 (R2′) arranged thereon. The accommodating case 10 of the present embodiment has two lateral walls, each of which has a first groove R1 (R1′) and a second groove R2 (R2′). Details of the first groove R1 (R1′) and the second groove R2 (R2′) will be described later.

The cover 30 has a plate portion 31 that can selectively cover the opening of the accommodating case 10, and a pair of connection walls 32 disposed on the underside of the cover 31. Each of the connection walls 32 has a first pivot A1 and a second pivot A2 protruding outwards. The first pivot A1 is movably disposed in the first groove R1 (R1′). The second pivot A2 is movably disposed in the second groove R2 (R2′). The first groove R1 (R1′) is substantially perpendicular to the plate portion 31. The second groove R2 (R2′) is slanted with respect to the first groove R1 (R1′). The assembly of the present embodiment disposes the cover 30 inside the accommodating case 10, then disposes the first pivot A1 and the second pivot A2 on the connection wall 32 respectively into the first groove R1 (R1′) and the second groove R2 (R2′). Details of the motion of the first pivot A1 and the second pivot A2 within respectively the first groove R1 and the second groove R2 are described later.

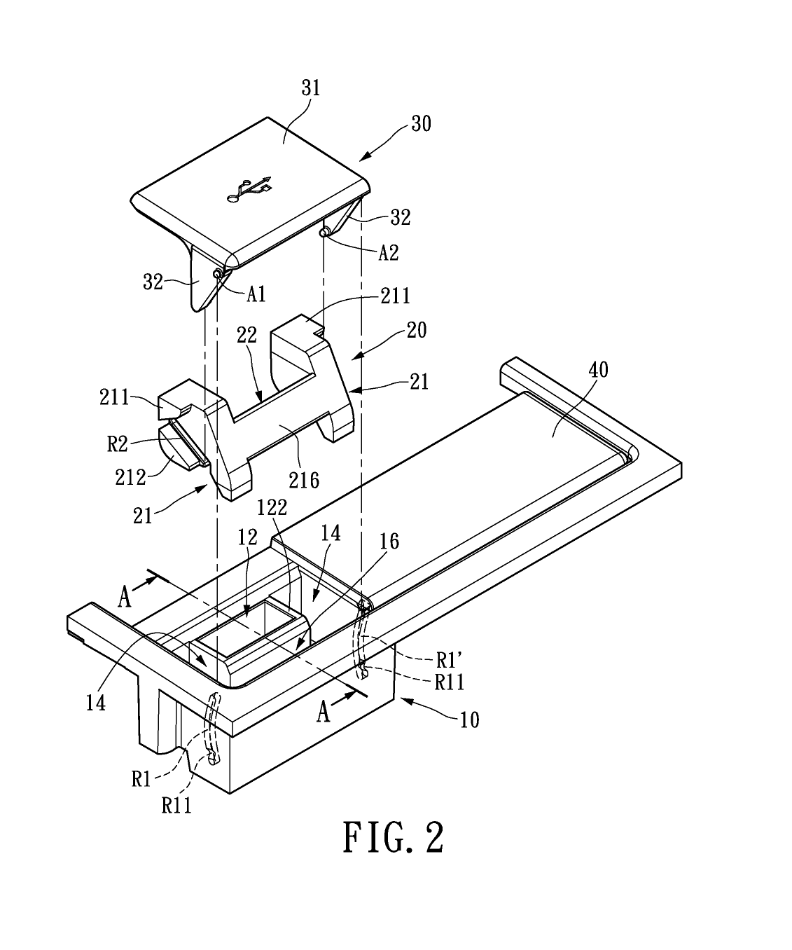

FIG. 2 shows a perspective exploded diagrams of the sliding cover structure of another embodiment according to the invention. The present embodiment differs from the above embodiment in that the sliding cover structure further includes an assembly unit 20. The assembly unit 20 is accommodated inside the accommodating case 10. The cover 30 is movably assembled between the accommodating case 10 and the assembly unit 20, such that the cover 30 is movably covering the accommodating case 10 or housed within the accommodating case 10. The above mentioned groove R2 is formed on the two lateral outer surfaces of the assembly unit 20 (the two lateral outer surfaces are symmetrical, the groove R2 on the other side is concealed and not shown in the figure). The advantage of the present embodiment is that the assembly is more convenient. First, the cover 30 is assembled onto the above mentioned assembly unit 20. Then, dispose the cover 30 and the assembly unit 20 together into the accommodating case 10 to complete the assembly, details of which is described later.

The interior of the above mentioned accommodating case 10 has a main receiving compartment 12 for accommodating electrical connectors (not shown in the figures), a pair of side receiving compartments 14 disposed on two sides of the main receiving compartment 12, and a cover receiving compartment 16. The cover receiving compartment 16 is disposed adjacent to the longer side of the main receiving compartment 12. Additionally, the cover receiving compartment 16 and the side receiving compartments 14 form a U shape surrounding the main receiving compartment 12. The main receiving compartment 12 of the present embodiment is enclosed by a rectangular inner case 122. The inner case 122 can accommodate an electrical connector or an external socket. However, the invention does not require an inner case 122. The electrical connector or the external invention can be directly disposed on an interior wall of the main receiving compartment 12.

The above mentioned assembly unit 20 includes a pair of assembly pieces 21 and a connecting portion 22 connecting the pair of assembly pieces 21. The assembly unit 20 is fixed within the accommodating case 10. More specifically, the assembly pieces 21 are respectively disposed in the side receiving compartments 14, and the connecting portion 22 is disposed in the cover receiving compartment 16. In the present embodiment, the second grooves R2 are formed respectively at the outer faces of the pair of assembly pieces 21.

In detail, the above mentioned assembly unit 20 has an outer slanted surface 216 facing upwards disposed on the connecting portion 22 and the assembly pieces 21. Each of the assembly pieces 21 of the present embodiment has an upper blocking member 211 and a lower blocking member 212 protruding on its lateral outer surface. The lower blocking members 212 are close to the lower edges of the second grooves R2. The upper blocking members 211 are substantially triangular. Each of the upper blocking members 211 has a slanted surface 2112 facing the second groove R2, and a guiding edge 2114 extending from the slanted surface 2112.

The connection walls 32 of the above mentioned cover 30 are substantially triangular, and are disposed in the side receiving compartments 14 of the accommodating case 10. In the present embodiment, the connection walls 32 of the cover 30 are respectively disposed at the lateral outer surfaces of the assembly pieces 21. In other words, the pair of assembly pieces 21 is disposed between the pair of connection walls 32. Every connection wall 32 has a first pivot A1 movably disposed in the first groove R1, and a second pivot A2 movably disposed in the second groove R2. The underside of the plate portion 31 has an embossed sealing block 33. The embossed block 33 coordinates with the closed position of the plate portion 31 to cover the main receiving compartment 12.

However the invention is not limited to the above embodiments. For example, the first pivot A1 and the second pivot A2 may be disposed on only one of the connection walls 32. Alternatively, in another embodiment wherein the accommodating case has two openings, in addition to the two connection walls 32 disposed on the two sides of the underside of the plate portion 31, the cover may also have a connection wall disposed in the middle of the underside of the plate portion. The pivots may be disposed on the middle connection wall. The connection walls 32 on the two sides do not both need to have a first and second pivots. Each of the two connection walls 32 may have only one of the two pivots.

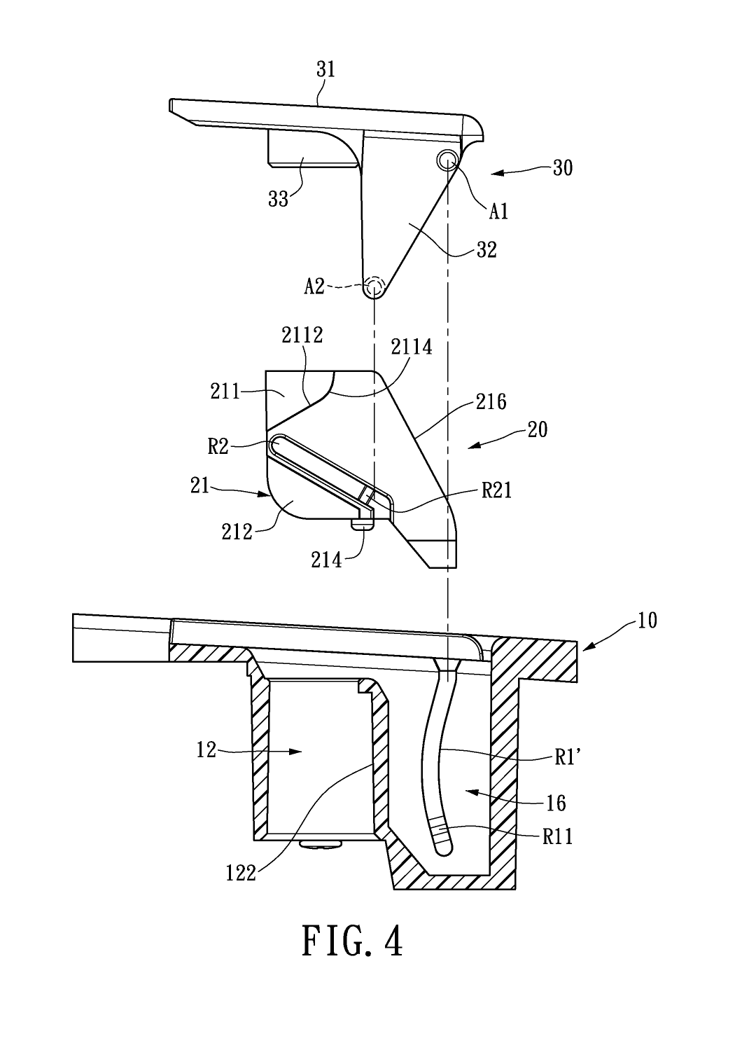

The arrangement of the grooves of the present embodiment is described in more detail in the following. Referring to FIG. 2 and FIG. 4, the first groove R1 is formed on the interior walls of the accommodating case 10, and the second groove R2 is formed on the lateral outer surface of the assembly piece 21. The first pivot A1 is disposed on the lateral outer surface of the connection wall 32 and is close to the plate portion 31. The second pivot A2 is disposed on the lower edge of the lateral inner surface of the connection wall 32. Referring to FIG. 4, the bottom end of the first groove R1 has a first retaining portion R11 to fasten the first pivot A1 and to hold the cover 30 in an open position. The bottom end of the second groove R2 has a second retaining portion R21 to fasten the second pivot A2 and to hold the cover 30 in a closed position. The underside of the assembly piece 21 has a positioning member 214 to be fixed to the accommodating case 10. The first retaining portion R11 and the second retaining portion R21 are protruding masses, which can block respectively the first pivot A1 and the second pivot A2, thereby holding the cover 30 in a stationary state.

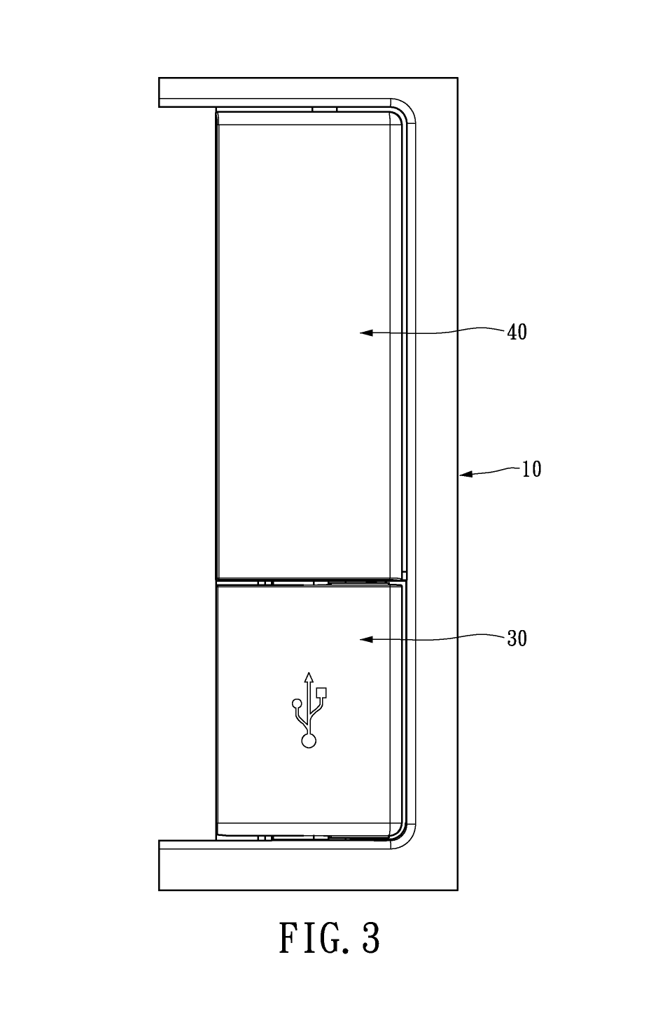

Please refer to FIG. 3 and FIG. 4. FIG. 3 is a top view assembly diagram of the sliding cover structure of the invention. FIG. 4 is a side view exploded diagram of the sliding cover structure of the invention (cross sectional view of the accommodating structure of FIG. 2 along line AA). For convenient assembly, in the invention one of the first grooves (the first groove R1′ on the right of FIG. 2) is open ended on top to allow the first pivots A1 to be assembled into the first grooves R1. The other first groove R1 is close ended on both ends. The present embodiment disposes the second grooves R2 on the pair of assembly pieces 21. Each of the second grooves R2 is open ended at its end closer to the bottom of the accommodating case 10.

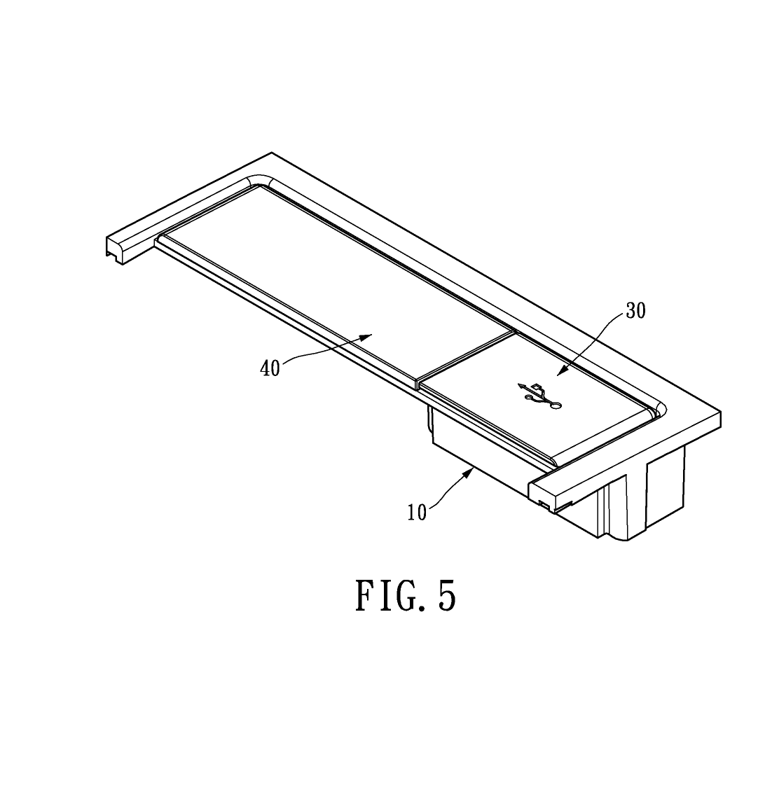

Referring to FIG. 4, during assembly of the present embodiment, the cover 30 is first combined with the assembly unit 20. First, the connection walls 32 are positioned on two sides of the pair of assembly pieces 21, and insert the second pivots A2 on connection walls 32 into the second grooves R2 from the underside of the assembly pieces 21. Then, the cover 30 and the assembly unit 20 are placed together into the accommodating case 10. In the process of placement, first the first pivot A1 is inserted into the first groove R1 which is closed on both ends (as shown in FIG. 2). Then, the other pivot A1 is inserted into the first groove R1′ which is open on one end. Finally, the invention further includes a decorative board 40 (as shown in FIG. 2) for covering the open ended first groove R1′. The perspective diagram after assembly is shown in FIG. 5.

Through the above arrangement, the invention disposes two pivots on the cover 30 to match the two sliding grooves. The plate portion 31 is selectively positioned at a closed position to cover the accommodating case 10, or at an open position housed within the cover receiving compartment 16 of the accommodating case 10. The following side view diagrams describe the operation of the cover with the grooves of the invention.

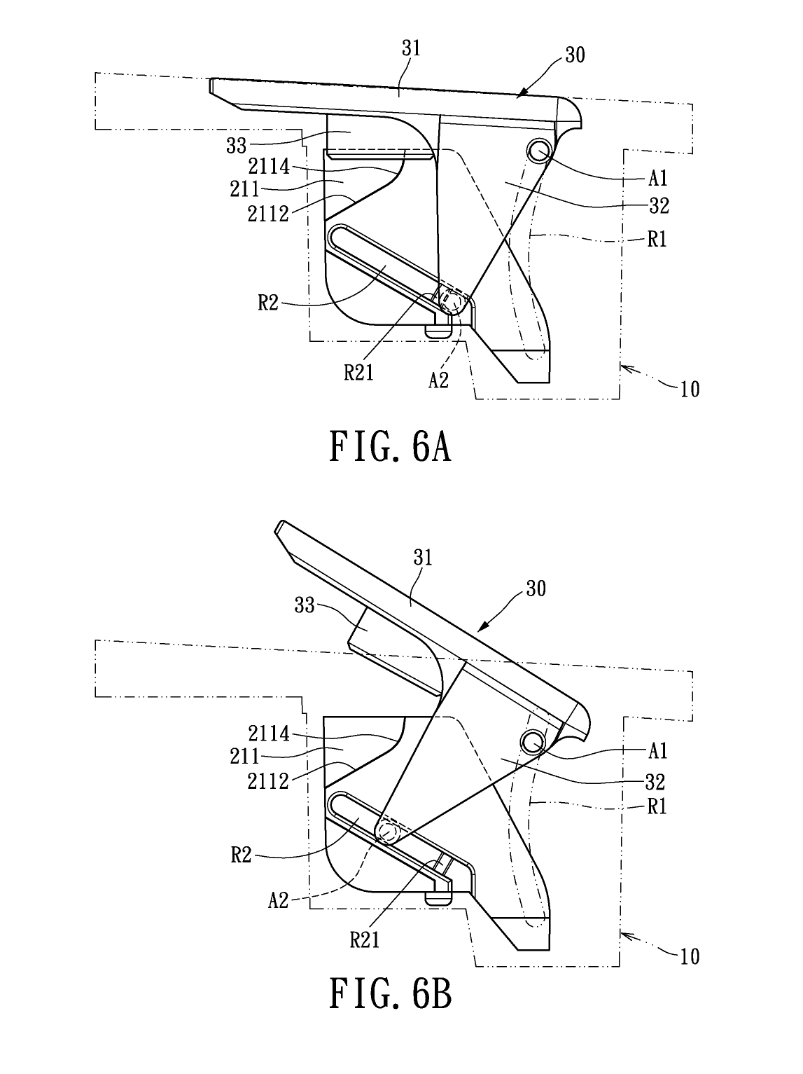

FIGS. 6A through 6D illustrate side view diagrams of the operation of the cover in accordance with the invention. A special feature of the invention lies in the configuration of the first groove R1 and the second groove R2. The first groove R1 is curved. The curvature faces the second groove R2. The direction of the first groove is substantially perpendicular to the plate portion 31. The second groove R2 is slanted with respect to the first groove R1.

In FIG. 6A, the cover 30 is in a closed position. The first pivot A1 is positioned at the top end of the first groove R1. The second pivot A2 is positioned at the bottom end of the second groove R2. At this moment, the cover 30 is held in place by the second retaining portion R21.

In FIG. 6B, the user pushes the outer edge of the plate portion 31. In other words, as shown in the figure, the left end (the higher end) of the plate portion 31 is pushed towards the right. Alternatively, the plate portion 31 can be pressed on the right side (the lower end). By these methods, the first pivot A1 can move downwards along the first groove R1. Due to the curvature of the first groove R1, the first groove R1 applies a reaction force on the first pivot A1. The first pivot A1 moves relatively slowly and acts as a fulcrum, while the wall 32 acts as a lever. This mechanism prompts the second pivot A2 to move away from the second retaining portion R21 and towards the top end of the second groove R2.

In FIG. 6C, the user continues pushing the outer edge of the cover 31 towards the right. The second pivot A2 moves to the top end of the second groove R2 and is held thereto. The second pivot A2 acts as a fulcrum, and the cover 30 pivots about the second pivot A2 to prompt the first pivot A1 to move downwards along the first groove R1. To further explain, when the connection wall 32 moves upwards and abuts the upper blocking member 211, the upper blocking member 211 provides a reaction force pushing against the connection wall 32 of the cover 30, aiding the cover 30 to successfully rotate. Moreover, the outer slanted surface 216 also aides the plate portion 31 to successfully move downwards.

In FIG. 6D, the user continues to push the outer edge of the plate portion 31 to the right until the first pivot A1 has passed the apex of the curvature of the groove R1. The plate portion 30 as a whole slips downward along the first sliding groove R1 into the accommodating case 10, until the first pivot A1 reaches the bottom end of the first groove R1. At this moment, the second pivot A2 slightly moves away from the top end of the second groove R2. Additionally, the connection wall 32 abuts the lower blocking member 212, resulting in a vertical open state of the plate portion 31.

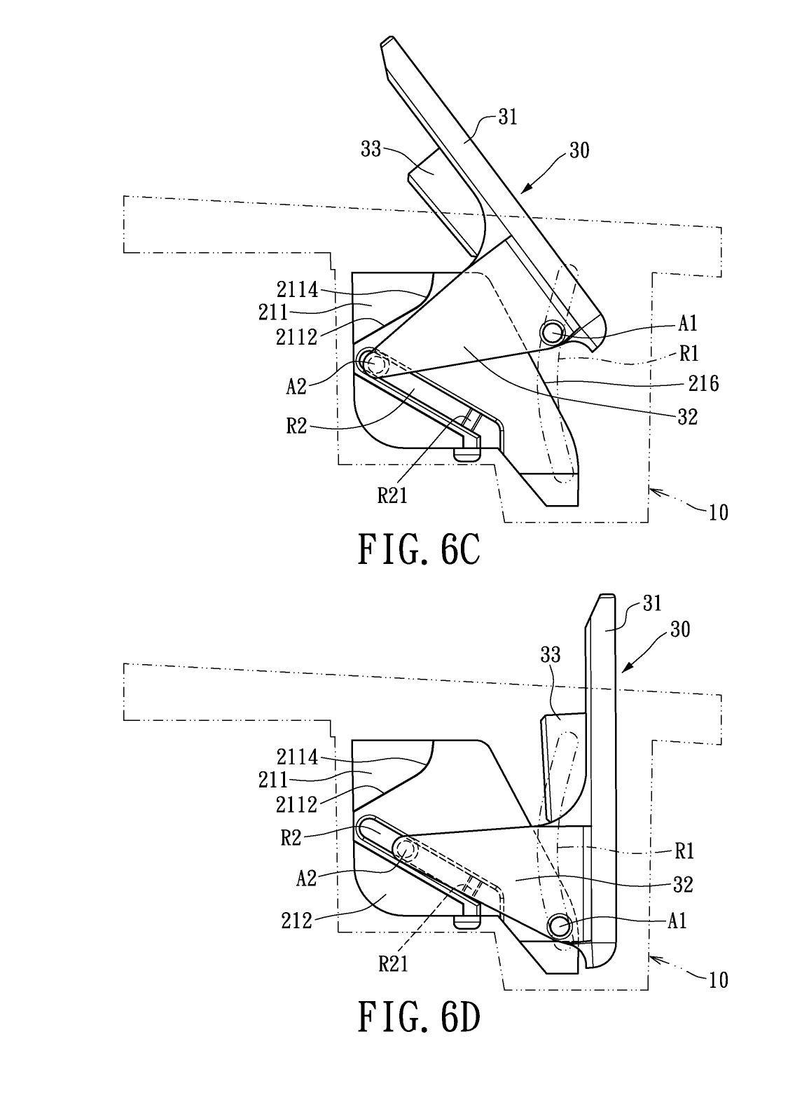

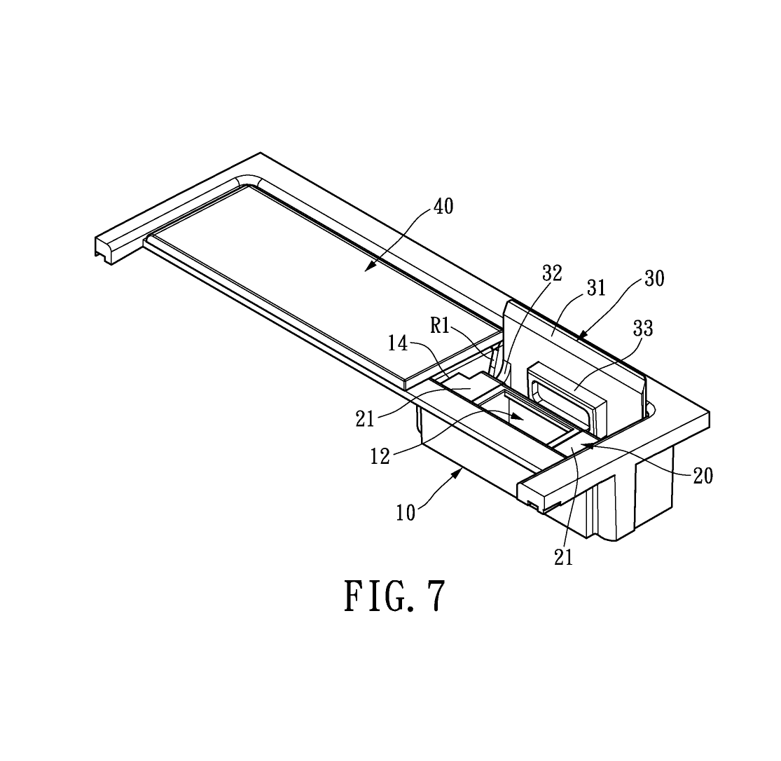

Referring to FIG. 7 and FIG. 8. When the cover 30 is in an open position, the plate portion 31 is mostly positioned inside the cover receiving compartment 16, so that the main receiving compartment 12 can be exposed to allow access by a user to operate the electrical connector or the electrical invention within. At the same time, a portion of the plate portion 31 is exposed outside the accommodating case 10, provided for the user to apply their finger with to push back to the closing position.

Similarly, the cover 30 of the invention can be pushed back into the closing position by the reverse process from FIG. 6D to FIG. 6A. More specifically, under the state of FIG. 6C when the cover is pushed towards the left side of the figure, the guiding edge 2114 of the upper blocking member 211 abuts the connection wall 32 and acts as a fulcrum, causing the first pivot A1 to move past the apex of curvature of the first groove R1 and continue moving upwards.

As an additional explanation, the configuration of the pivot and the groove is not limited to the above description. For example, the two above mentioned pivots can be disposed on the same side of the connection wall 32, either the inner or the outer lateral surface. Likewise, the above two grooves R1 and R2 can be disposed on the interior walls on two sides of the accommodating case 10, or alternatively the second groove can be disposed on the lateral outer surface of the inner case 122 in the main receiving compartment 12.

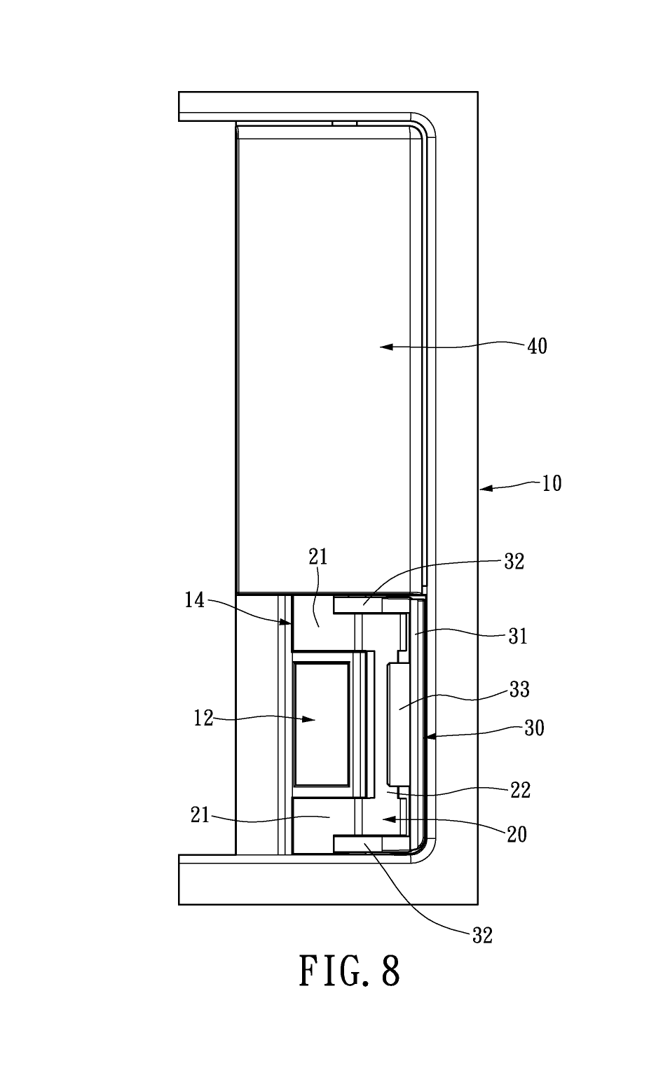

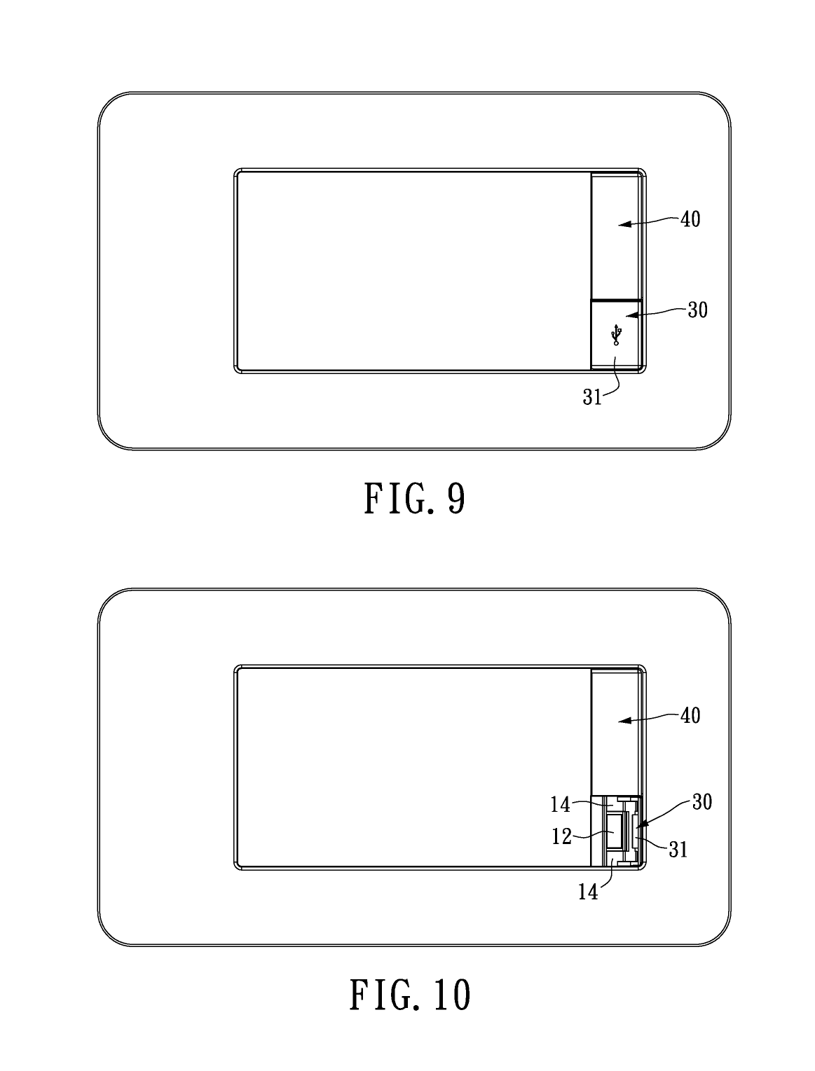

FIG. 9 and FIG. 10 are respectively top view diagrams of the sliding cover structure of the invention applied on an electronic device in a close and open state. The sliding cover structure of the present embodiment is applied on electrical devices, even more suitably on connectors with small covers such as the USB connector. Given that sliding structures on small electrical connectors need to be smaller, potentially smaller than fingers are, they are more difficult to be pulled out by fingers. The cover 30 of the invention can be opened by directly pressing the plate portion 31 with the finger, without the need to pull the cover.

The invention has at least the following advantages:

1. The invention applies two pivots to match two uniquely arranged grooves, minimizing the space of rotation of the structure, effectively reducing the operation space of the structure, further reducing the volume.

2. The invention provides the user a cover 30 which can be easily pushed to be successfully opened or closed, and a connecting rod whose two ends move on two sliding grooves in an anticipated motion within the restricting guiding grooves. The cover 30 can be successfully opened or closed by merely pressing or pushing. Pulling by fingers is not required.

3. A big portion of the cover of the invention is housed within the receiving compartment when open, further reducing the likelihood of damage through impact.

4. The assembly unit 20 of the invention restricts the movement of the cover 30, preventing the cover 30 from detaching from the accommodating case 10, and also guides the cover 30 to slip into the receiving compartment during the motion of sliding.

The descriptions illustrated supra set forth simply the preferred embodiments of the invention; however, the characteristics of the invention are by no means restricted thereto. All changes, alternations, or modifications conveniently considered by those skilled in the art are deemed to be encompassed within the scope of the invention delineated by the following claims.

1. A sliding cover structure, comprising:
an accommodating case having an opening, two opposite interior walls, a front wall and a lateral wall;
a pair of curved first grooves formed symmetrically on the two opposite interior walls of the accommodating case, wherein each curved first groove has a first end and a second end;
an assembly unit disposed in the accommodating base and having two opposite outer surfaces facing the two opposite interior walls, respectively;
a cover having a plate portion selectively covering the opening, two opposite sides corresponding to the two opposite interior walls, respectively, and a lateral side corresponding to the lateral wall of the accommodating case;
a pair of connection walls formed on the two opposite sides of the plate portion, respectively, and extending perpendicularly from the plate portion, the connection walls having outer surfaces facing the two opposite interior walls, respectively, and having inner surfaces opposite to the outer surfaces, respectively; each connection wall having a slant side, which is slant relative to the plate portion, wherein the slant side has a first end close to the lateral side of the cover, and a second end further apart from the lateral side the cover;
a pair of substantially straight second grooves formed on the two outer surfaces of the assembly unit and corresponding to the pair of curved first grooves, respectively, each second groove having a first end and a second end;
a first protruding pivot formed on at least one of the connection walls, and a second protruding pivot formed on at least one of the connection walls;
wherein the cover is rotatably coupled to the accommodating case and the assembly unit with approximately 90 degrees by the first pivot cooperating with the corresponding first groove and the second pivot cooperating with the corresponding second groove,
wherein the cover is selectably positioned in a closed position covering the accommodating case and in an open position recessed into the accommodating case.

2. The sliding cover structure according to claim 1, wherein the extending direction of each first groove is substantially perpendicular to the plate portion when the cover is positioned in the closed position, and wherein each second groove is slantingly arranged with respect to the corresponding first groove.

3. The sliding cover structure according to claim 2, wherein the inside of the accommodating case defines a main receiving compartment, a cover receiving compartment positioned on one side of the main receiving compartment, and a pair of side receiving compartments on two sides of the main receiving compartments, and the pair of connection walls is accommodated in the pair of side receiving compartments.

4. The sliding cover structure according to claim 3, wherein the assembly piece has a pair of assembly pieces, wherein the pair of assembly pieces is oppositely disposed in the pair of side receiving compartments, and wherein the second grooves are respectively formed on the assembly pieces.

5. The sliding cover structure according to claim 4, wherein the assembly piece has a connecting portion integrally connecting the pair of assembly pieces.

6. The sliding cover structure according to claim 4, wherein the first pivot is formed on the outer surfaces of the corresponding connection wall, and wherein the second pivot is formed on the inner surfaces of the corresponding connection wall, and wherein the first protruding pivot is formed close to the first end of the slant side of the corresponding connection wall, and the second protruding pivot is formed close to the second end of the slant side of the corresponding connection wall.

7. The sliding cover structure according to claim 6, wherein the first end of each second groove is open ended closer to the bottom of the accommodating case, and the first end of each first groove is open ended, to allow the first pivot to be inserted into the corresponding first groove.

8. The sliding cover structure according to claim 7, further comprising a decorative board for covering the open ended first grooves.

9. The sliding cover structure according to claim 4, wherein each of the assembly pieces has two upper blocking members and two lower blocking members protruding on the outer surfaces of the assembly unit, and the lower blocking members are respectively close to the second grooves.

10. The sliding cover structure according to claim 9, wherein each upper blocking member is substantially triangular, and has a slanted surface facing the corresponding second groove and a guiding edge extending from the slanted surface.

11. The sliding cover structure according to claim 1, wherein the first protruding pivot is formed close to the first end of the slant side of the corresponding connection wall, and the second protruding pivot is formed close to the second end of the slant side of the corresponding connection wall, and wherein the direction of each first groove is substantially perpendicular to the plate portion, each second groove is slanted with respect to the corresponding first groove, a first retaining portion is formed at the second end of each first groove for retaining the first pivot and holding the cover in the open position, a second retaining portion is formed at the first end of each second groove for retaining the second pivot and holding the cover in the closed position.

12. The sliding cover structure according to claim 2, wherein an embossed sealing block is disposed on an underside of the plate portion, and the embossed sealing block coordinates with the closed position of the plate portion to cover the main receiving compartment.

13. A sliding cover structure, comprising:
an accommodating case having an opening, two opposite interior walls, a front wall and a lateral wall;
a pair of curved first grooves formed symmetrically on the two opposite interior walls of the accommodating case, wherein each curved first groove has a first end and a second end;
an assembly unit disposed in the accommodating base and having two opposite outer surfaces facing the two opposite interior walls, respectively;
a cover having a plate portion selectively covering the opening, two opposite sides corresponding to the two opposite interior walls, respectively, and a lateral side corresponding to the lateral wall of the accommodating case;
a pair of connection walls formed on the two opposite sides of the plate portion, respectively, and extending perpendicularly from the plate portion, the connection walls having outer surfaces facing the two opposite interior walls, respectively, and having inner surfaces opposite to the outer surfaces, respectively; each connection wall having a slant side, which is slant relative to the plate portion, wherein the slant side has a first end close to the lateral side of the cover, and a second end further apart from the lateral side the cover;
a pair of substantially straight second grooves formed on the two outer surfaces of the assembly unit and corresponding to the pair of curved first grooves, respectively, each second groove having a first end and a second end;
a pair of first protruding pivots formed on the outer surfaces of the pair of connection walls, respectively, and a pair of second protruding pivots formed on inner surfaces, respectively;
wherein each first protruding pivot is formed close to the first end of the slant side of the connection wall, and each second protruding pivot is formed close to the second end of the slant side of the connection wall;
wherein each curved first groove and a corresponding substantially straight groove is configured in such a way that when the cover is in a closed position covering the accommodating case, the first protruding pivot is positioned in the first end of the curved first groove, the second protruding pivot is positioned in the first end of the substantially straight groove, and the first protruding pivot is pushed to slide from the first end to the second end of the curved first groove along the curvature of the curved first groove, meanwhile, when the first protruding pivot slides from the first end to the second end of the curved first groove, the slant side of the connection wall acts as a lever to push the second protruding pivot to slide from the first end towards the second end of the substantially straight second groove, and when the first pivot reaches the second end of the curved first groove, the cover is recessed into the accommodating case and is thus in an open position.

14. The sliding cover structure according to claim 13, wherein the extending direction of each first groove is substantially perpendicular to the plate portion when the cover is positioned in the closed position, and wherein each second groove is slantingly arranged with respect to the corresponding first groove.

15. The sliding cover structure according to claim 14, wherein the inside of the accommodating case defines a main receiving compartment, a cover receiving compartment positioned on one side of the main receiving compartment, and a pair of side receiving compartments on two sides of the main receiving compartments, and the pair of connection walls is accommodated in the pair of side receiving compartments.

16. The sliding cover structure according to claim 15, wherein the assembly piece has a pair of assembly pieces, wherein the pair of assembly pieces is oppositely disposed in the pair of side receiving compartments, and wherein the second grooves are respectively formed on the assembly pieces.

17. The sliding cover structure according to claim 16, wherein the assembly piece has a connecting portion integrally connecting the pair of assembly pieces.

18. The sliding cover structure according to claim 13, wherein the first end of each second groove is open ended closer to the bottom of the accommodating case, and the first end of each first groove is open ended, to allow the first pivot to be inserted into the corresponding first groove.

19. The sliding cover structure according to claim 16, wherein each of the assembly pieces has two upper blocking members and two lower blocking members protruding on the outer surfaces of the assembly unit, and the lower blocking members are respectively close to the second grooves.

20. The sliding cover structure according to claim 13, wherein the direction of each first groove is substantially perpendicular to the plate portion, each second groove is slanted with respect to the corresponding first groove, a first retaining portion is formed at the second end of each first groove for retaining the first pivot and holding the cover in the open position, a second retaining portion is formed at the first end of each second groove for retaining the second pivot and holding the cover in the closed position.
